(19) United States
(12) Patent Application Publication
(10) Pub. No.: US 2018/0081671 A1
(43) Pub. Date: Mar. 22, 2018

(54) PROGRAM REWRITING DEVICE AND PROGRAM REWRITING METHOD

(71) Applicant: HONDA MOTOR CO., LTD., Tokyo (JP)

(72) Inventors: Kuniharu NARUSE, Minato-ku, Tokyo (JP); Shinya YOSHINO, Minato-ku, Tokyo (JP); Shun FUJITSUKA, Minato-ku, Tokyo (JP)

(21) Appl. No.: 15/562,153

(22) PCT Filed: Mar. 22, 2016
(86) PCT No.: PCT/JP2016/058908

§ 371 Date: Sep. 27, 2017

(30) Foreign Application Priority Data
Mar. 30, 2015 (JP) 2015-068855
Mar. 30, 2015 (JP) 2015-068885
Mar. 30, 2015 (JP) 2015-068949

(51) Int. Cl. G06F 9/445; B60R 16/023; G06F 17/30

(52) U.S. Cl. CPC G06F 8/65; G06F 17/30371; B60R 16/0231

(57) ABSTRACT

The present invention provides a program rewriting device and a program rewriting method capable of easily rewriting a program. A rewriting control unit of a program rewriting device compares the current version information that is read from all rewritable ECUs included in a network with the latest version information corresponding to the current version information and extracts, as target ECUs, rewriting candidate ECUs in which the current version information does not match the latest version information. The rewriting control unit sequentially performs a program rewriting action for the extracted target ECUs in order of priority stored in an order DB.

### TECHNICAL FIELD

The present invention relates to a program rewriting device and a program rewriting method for connecting to a network of electronic control units (hereinafter referred to as “ECUs”) in a vehicle from the outside of the vehicle, selecting an ECU requiring program rewriting and rewriting the program.

### BACKGROUND ART

A large number of ECUs are mounted on a vehicle in recent years. Version upgrading of programs may be performed in response to partial improvement of control specifications and the like. In that case, program rewriting may be required for a plurality of related ECUs.

Many of the plurality of ECUs installed in a vehicle have a function of monitoring abnormality mutually by communication. For this reason, in program rewriting, in order to rewrite a program in one ECU, it is necessary to request the ECU to allow program writing from an external program rewriting device, and also to suspend failure diagnosis so that a communication abnormality occurring between the rewriting target ECU and another ECU is not judged as a failure. Further, after rewriting, in order to unsuspend the failure diagnosis, it is required to perform a restart operation of turning on the vehicle again after turning off an ignition switch of the vehicle.

Therefore, in a rewriting operation at a dealer or the like that maintains vehicles, rewriting is performed one by one for a plurality of rewriting target ECUs corresponding to one rewrite. Since an ignition switch is turned off and then turned on at every rewrite on each of the ECUs, program rewriting is a very burdensome operation.

To reduce the burden, Japanese Laid-Open Patent Publication No. 2012-091755 (hereinafter referred to as “JP 2012-091755 A”) proposes to reboot a plurality of ECUs collectively after acquiring rewrite data of the plurality of ECUs to be rewritten via a medium such as a CD-ROM, a mobile communication network or the like, and rewrite programs on the plurality of ECUs which mutually perform cooperative control.

### SUMMARY OF INVENTION

The method of JP 2012-091755 A makes it easy to perform the rewrite operation itself. However, in consideration of data such as identification information of the plurality of ECUs to be rewritten, compatibility information of the programs, combinations of target ECUs for cooperative control, designation of rewriting order needs to be created beforehand. For this reason, it takes a lot of trouble to prepare the data each time it is rewritten.

In addition, since the amount of data such as a program is large, it is necessary to provide an associated set of information for checking whether there is no mistake in the data or data is normal. Further, when rewriting fails in some of the ECUs to be rewritten, consideration of the order of rewriting in balance with portions where normal rewriting is completed is required for another rewriting. For this reason, it may take a lot of time and effort to repair.

It is an object of the present invention to provide a program rewriting device and a program rewriting method capable of easily rewriting a program, taking the above-mentioned problems into consideration.

A program rewriting device according to the present invention includes a network connector for connecting from an outside of the vehicle a network of electronic control units (hereinafter referred to as “ECUs”) in a vehicle, and a rewrite controller configured to rewrite program on ECUs selected as requiring program rewriting (hereinafter referred to as “target ECUs”), wherein the program rewriting device further includes an order database in which a priority order is stored beforehand in association with identification codes of all rewritable ECUs mounted on the vehicle, a rewrite candidate information database in which rewrite candidate information is stored as a set of the identification codes of rewrite candidate ECUs as candidates of the target ECUs and latest version information of programs installed in the rewrite candidate ECUs per target operation to be changed in the vehicle which requires program rewriting, and a rewrite program database in which a rewrite program is stored, wherein the rewrite controller is configured to read out from all the rewritable ECUs in the network the identification codes and current version information of the installed programs of the ECUs in pairs, extract, as the target ECUs, the rewrite candidate ECUs paired with the current version information mismatching with the latest version information based on a comparison between the current version information which has been read out and the latest version information corresponding to the current version information, and execute program rewriting operation on the extracted target ECUs successively in the priority order stored in the order database.

According to the present invention, program rewriting is performed in the priority order corresponding to a combination of ECUs (target ECUs) that need to be rewritten in each target operation of the vehicle to be changed. Therefore, program rewriting can be performed in the most appropriate order for the vehicle.

Further, according to the present invention, rewriting to the latest version of the program is successively executed on the target ECUs that are the rewrite candidate ECUs for which current version information and the latest version information do not coincide with each other, in accordance with the priority order of each change target operation. For this reason, rewriting is performed only on the rewrite candidate ECUs that need to be rewritten, so that rewriting operation can be performed efficiently.

According to the above, even when a service provider such as a dealer performs program rewriting of vehicles on the market, there is no mistake in selecting the target ECU by the maintenance operator (operator). In addition, it is possible to reduce the burden of operation for specifying the rewriting order, and it is possible to implement an appropriate rewriting operation easily.

Even if there is a target ECU that failed to be rewritten during program rewriting, rewriting can be performed only for the target ECU that has not been rewritten by performing the program rewriting again, not for the target ECU that has already been rewritten.

The rewrite controller registers the rewrite candidate ECU that is paired with the current version information that does not match the latest version information as the target ECU in a list, and executes the program rewriting operation in the priority order stored in the database with respect to the target ECU registered in the list. This makes it possible to identify a combination of target ECUs requiring program rewriting (or a combination of programs corresponding to the target ECU) by a simple method.

The priority order stored in the order database is among all the rewritable ECUs, an ECU, which utilizes data of another ECU, is prioritized in rewriting order over the other ECU to be utilized. A gateway ECU having a gateway function in the network has a lower priority in execution of the program rewriting operation than other target ECUs to which communication is relayed. Thus, when rewriting a plurality of ECUs successively, programs of the gateway ECU and other target ECUs are rewritten successively without being affected by changes in data to be used in rewriting of other cooperating ECUs.

In the case where the rewrite program database stores the latest versions of the rewrite programs having the same identification codes and there are a plurality of target operations to be changed, the rewrite controller may use the rewrite candidate information corresponding to the newest target operation to be changed. In the case where a plurality of target operations of the vehicle are prepared (or stored) to be changed, the latest rewrite candidate information includes the new version of the rewrite program. If rewriting is performed based on the latest rewrite candidate information, the program of the ECU to be rewritten will be rewritten to the new version. Therefore, even if the same ECU is included in rewriting based on the previous rewrite candidate information, it is not necessary to rewrite the program installed in the same ECU. Thus, it is possible to shorten the operation time of the operator in a case where there are a plurality of rewrite candidate information.

The rewrite controller may transmit a stop/prohibition request signal for requesting all the ECUs to stop mutual communication and prohibit storage of failure codes; perform the program rewriting operation successively to the target ECUs while the stop/prohibition request signal is being transmitted; set to transmit an operation check signal to each of the target ECUs after completion of the program rewriting operation in all the target ECUs; terminate transmission of the stop/prohibition request signal upon detecting stoppage of all the target ECUs based on no response to the operation check signal;

transmit a version information request signal for requesting all the target ECUs for the version information of the programs installed in the target ECUs; and check if the version information received from all the target ECUs is the latest version.

According to the present invention, before the rewriting of the program, stop all mutual communication in the ECUs and prohibit saving of the failure code. When successive program rewriting in all target ECUs is completed, after stoppage of all target ECUs is confirmed, the stop of mutual communication and prohibition of storage of failure codes are canceled. Thereafter, a signal requesting the version information of the installed program is transmitted to the target ECUs, and the completion of the program rewriting is confirmed based on the version information received from the target ECUs.

Accordingly, it is possible to reduce the burden on the operator drastically by performing the operation for restarting the target ECUs (restart operation) collectively after the successive program rewriting of all the target ECUs. Therefore, even when program rewriting of a vehicle on the market is performed by a maintenance operator such as a dealer or the like, appropriate rewriting operation can be easily performed.

The rewrite controller sequentially transmits the operation check signal to the target ECUs one by one after the completion of the program rewriting operation in all the target ECUs, and detects that all the target ECUs are stopped based on no response to the operation check signal. In this case, since only the stoppage of the ECUs rewritten is detected, judgment becomes easier compared to the case where the operation check signal is transmitted to all the rewritable ECUs (target ECUs) at a time, and the time required for checking can be shortened. Further, with regard to the target ECUs that have performed the rewriting operation, the stop is detected with no response to the operation check signal, and the subsequent processing is performed, so that it is possible to restart each target ECU reliably.

The rewrite controller may cause the display unit to display an off operation request for requesting an off operation of a power supply for the ECU in the vehicle after the program rewriting operation for all the target ECUs is completed, and display an re-energization request for requesting the re-energization for the ECUs after detecting the stoppage of all the target ECUs and terminating the transmission of the stop/prohibition request signal. As a result, in order to make the re-energization operation request, confirmation of power off in all target ECUs is a condition. Therefore, even in the case where the number of target ECUs is large or there is a target ECUs having been turned off for a long time, it is possible to instruct the restart operation after surely turning off all the target ECUs.

When rewriting the program, the rewrite controller may confirm that there is no communication failure history related to the network with respect to all of the rewritable ECUs. When it can be confirmed that none of the ECUs has the communication failure history, the rewrite controller may check the identification codes of the ECUs read out from all the rewritable ECUs with the identification codes of rewrite candidate ECUs included in the rewrite candidate information to specify the target ECUs, and execute program rewriting in the order stored in the order database in the specified target ECUs.

According to the present invention, prior to program rewriting in the target ECUs, it is confirmed that there is no communication failure history with respect to each of the target ECUs. As a result, it is possible to confirm before starting program rewriting the reason of communication failure between the program rewriting device and the target ECU, the vehicle to which the program rewriting device is connected is not equipped with the target ECU, or the target ECU is mounted on the vehicle but suffered from communication failure. Therefore, it is possible to prevent a communication failure from being misunderstood that the target ECU is not installed. Therefore, it is possible to reduce the trouble of rewriting the program.

The rewrite controller inquires the communication failure history to the gateway ECU, and thereafter inquires of the ECU other than the gateway ECU about the communication failure history, thereby confirming that there is no communication failure history. In this manner, when it is impossible to communicate with the target ECU, it is possible to facilitate finding of the part causing a failure by confirming whether the gateway ECU or the target ECUs themselves or another ECU causes the problem.

A program rewriting method according to the present invention is a method for rewriting a program in a program rewriting device including a network connector to be connected from an outside of a vehicle to a network of electronic control units (hereinafter referred to as “ECUs”) inside the vehicle, and a rewrite controller for selecting an ECU that needs program rewriting, hereinafter referred to as a “target ECU”, the program rewriting device comprising: an order database in which a priority order is stored beforehand in association with identification codes of all rewritable ECUs mounted on the vehicle; a rewrite candidate information database in which rewrite candidate information is stored as a set of the identification codes of rewrite candidate ECUs as candidates of the target ECUs and latest version information of programs installed in the rewrite candidate ECUs per target operation to be changed in the vehicle which requires program rewriting; and a rewrite program database in which a rewrite program is stored, wherein the program rewriting method comprising steps, executed by the rewrite controller, of: reading out from all the rewritable ECUs in the network the identification codes and current version information of the installed programs of the ECUs in pairs; extracting, as the target ECUs, the rewrite candidate ECUs paired with the current version information mismatching with the latest version information based on a comparison between the current version information which has been read out and the latest version information corresponding to the current version information; and executing program rewriting operations on the extracted target ECUs successively in the priority order stored in the order database.

### BRIEF DESCRIPTION OF DRAWINGS

FIG. 1 is a schematic diagram simply showing a program rewriting system including a program rewriting device according to the present embodiment;

FIG. 2 is a view conceptually showing a structure of a memory in the embodiment;

FIG. 3 is a flowchart for program rewriting in the embodiment;

FIG. 4 is a flowchart of a process of selecting a combination of rewrite candidate ECUs in the embodiment (details of step S4 in FIG. 3);

FIG. 5 is a flowchart of a process of successive program rewriting in the embodiment (details of step S8 in FIG. 3);

FIG. 6 is an explanatory diagram of communication and operation states of the program rewriting device and each electronic control device in the successive program rewriting process and a rewrite completion confirmation process in the embodiment;

FIG. 7 is a flowchart of the rewrite completion confirmation process in the embodiment (details of step S9 in FIG. 3);

FIG. 8 is a chart showing an example for confirming in turns whether each target electronic control unit is turned off in a comparative example; and

FIG. 9 is a chart showing an example for confirming in turns whether each target electronic control unit is turned off in the embodiment.

### DESCRIPTION OF EMBODIMENTS

### A. One Embodiment

### [A1. Configuration of Program Rewriting System 10]

### (A1-1. Overall Configuration)

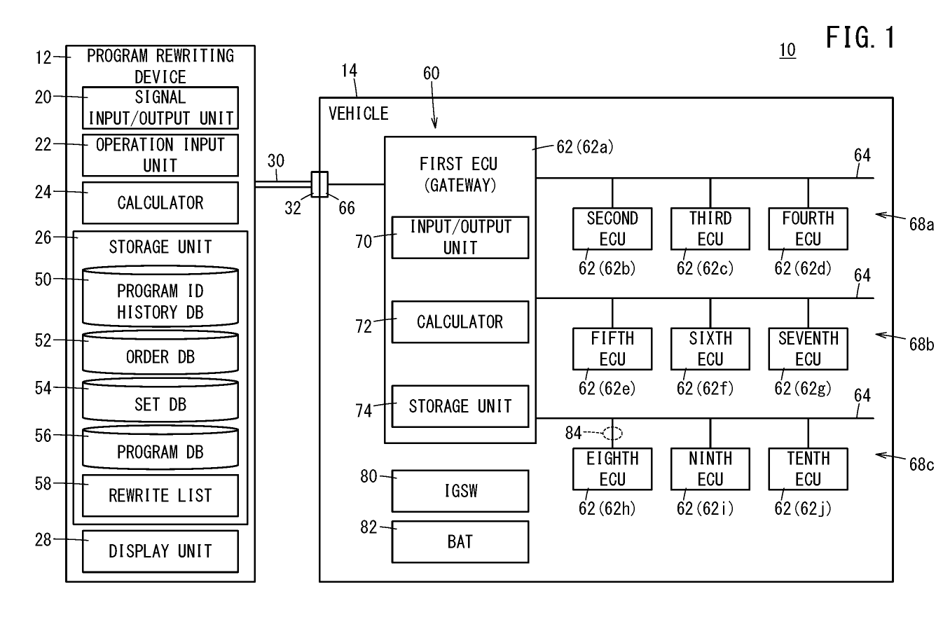

FIG. 1 is a schematic view simply showing a program rewriting system 10 (hereinafter also referred to as “rewriting system 10” or “system 10”) including a program rewriting device 12 (hereinafter also referred to as “rewriting device 12”) according to an embodiment of the present invention. The system 10 includes a vehicle 14 in addition to the rewriting device 12. In FIG. 1, although one rewriting device 12 and one vehicle 14 are shown, a plurality of rewriting devices 12 and a plurality of vehicles 14 may be provided.

### (A1-2. Program Rewriting Device 12)

### (A1-2-1. Overall Configuration of the Program Rewriting Device 12)

The rewriting device 12 rewrites (or updates) a program installed in one of first to tenth electronic control units 62a to 62j (hereinafter referred to as “first to tenth ECUs 62a to 62j” or “ECUs 62a to 62j”) of the vehicle 14 as a program rewriting target. Hereinafter, the ECUs 62a to 62j are collectively referred to as the ECUs 62. Among the ECUs 62, the one subject to program rewriting is also referred to as “target ECU 62tar”. The program installed in the ECUs 62 is also referred to as “installed program Pi” or “program Pi”.

As shown in FIG. 1, the rewriting device 12 includes a signal input/output unit 20, an operation input unit 22, a calculator 24, a storage unit 26, and a display unit 28.

The signal input/output unit 20 (network connector unit) inputs and outputs a signal to/from the vehicle 14. The signal input/output unit 20 includes a data cable 30 and a data link connector 32 (hereinafter also referred to as “DLC 32”), and is connected to a communication network 60 in the vehicle 14 from the outside of the vehicle 14.

The operation input unit 22 receives an operation input from a user (or an operator) of the rewriting device 12. In the present embodiment, the operation input unit 22 functions as a selector that selects a target operation Otar of the vehicle 14 to be changed. The target operation Otar to be changed referred to herein means, for example, an operation to be performed on the vehicle 14 in order to improve the performance (fuel efficiency, turning performance, etc.) of the vehicle 14 or to eliminate a problem in the vehicle 14.

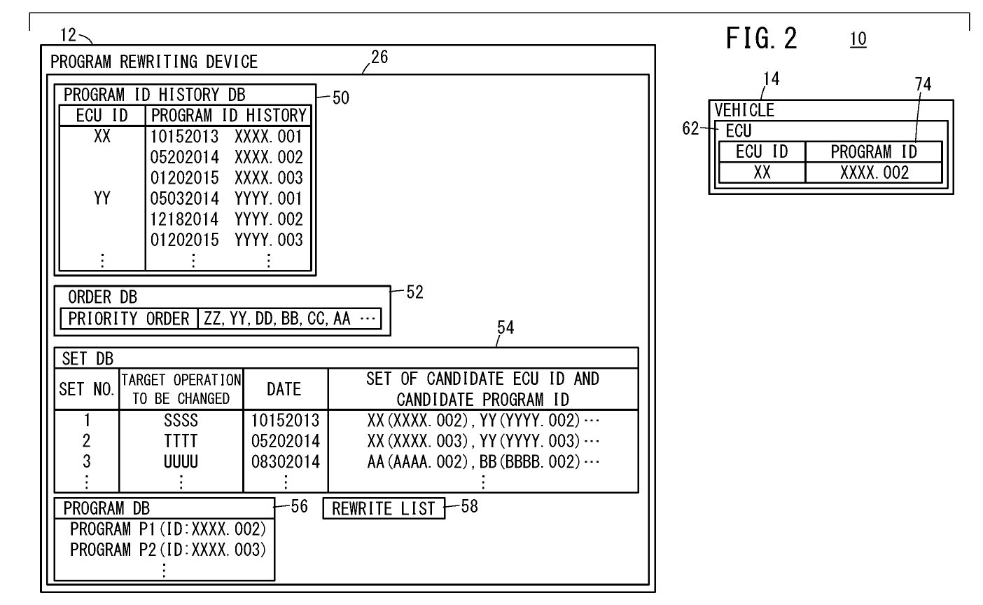

The calculator 24 (rewrite controller) controls each unit of the rewriting device 12 and controls program rewriting for the target ECU 62tar of the vehicle 14. The calculator 24 includes, for example, a central processing unit (CPU). Details of the operation of the calculator 24 will be described later with reference to FIGS. 2 to 9.

The storage unit 26 has a volatile memory and a nonvolatile memory (not shown), and stores various programs to be executed by the calculator 24 and various data and programs for rewriting (hereinafter also referred to as “rewrite program Pr” or “program Pr”.) Hereinafter, the installed program Pi and the rewrite program Pr are collectively referred to as a program P.

The display unit 28 displays a display screen relating to program rewriting or the like. By using the display unit 28 as a touch panel, the operation input unit 22 and the display unit 28 may be integrated.

### (A1-2-2. Storage Unit 26)

FIG. 2 is a diagram conceptually describing the configuration of the storage unit 26 in the present embodiment. In FIG. 2, only one ECU 62 is shown, and illustration of the other ECUs 62 is omitted. As shown in FIGS. 1 and 2, the storage unit 26 stores a program ID history database 50 (hereinafter also referred to as “program ID history DB 50”), a rewriting order database 52 (hereinafter also referred to as “order DB 52”), a rewriting set information database 54 (hereinafter also referred to as “set DB 54”), a rewrite program database 56 (hereinafter also referred to as “program DB 56”), and a program rewrite list 58 (hereinafter also referred to as “rewrite list 58” or “list 58”).

The program ID history DB 50 stores identification information of the program P (hereinafter referred to as “program ID”) in association with identification information of the ECU 62 (Hereinafter referred to as “ECU ID”) and dates (see FIG. 2). In the present embodiment, the program ID includes a program name and version information Iver. For example, the program ID is written as “XXXX.001”. Among these, “XXXX” corresponds to the program name, and “001” is the version information Iver. The ECU ID also means the identification information (system ID) of the lower system controlled by each of the ECUs 62.

The order DB 52 stores in advance priority order information Ipo (hereinafter also referred to as “order information Ipo”) indicating the priority order Op of rewriting, corresponding to identification information (ECU ID) of all rewritable ECUs 62 mounted on the vehicle 14 (see FIG. 2). The order information Ipo of the present embodiment includes the priority order Op of the ECUs 62 installed in the vehicles 14 of plural types of vehicles. The priority order Op in this embodiment is indicated by the arrangement order of ECU IDs. For this reason, the order information Ipo collectively shows, for example, the order of priority Op of the ECU 62 mounted on the vehicle 14 of a first model type (for example, those having the ECU IDs of XX, YY, ZZ in FIG. 2) and the priority order Op of the ECU 62 mounted on the vehicle 14 of a second model type (for example, those having the ECU IDs of AA, BB, CC, DD in FIG. 2). Alternatively, the order information Ipo may indicate only the priority order Op of the ECU 62 installed in the vehicle 14 of a single vehicle type.

In the example of FIG. 2, the arrangement order indicates the priority order Op (hereinafter also referred to as “rewriting priority order Op” or “rewriting order Op”). However, for example, it is also possible to include the rewriting order Op in the order information Ipo as “1: ZZ, 2: YY, 3: XX”.

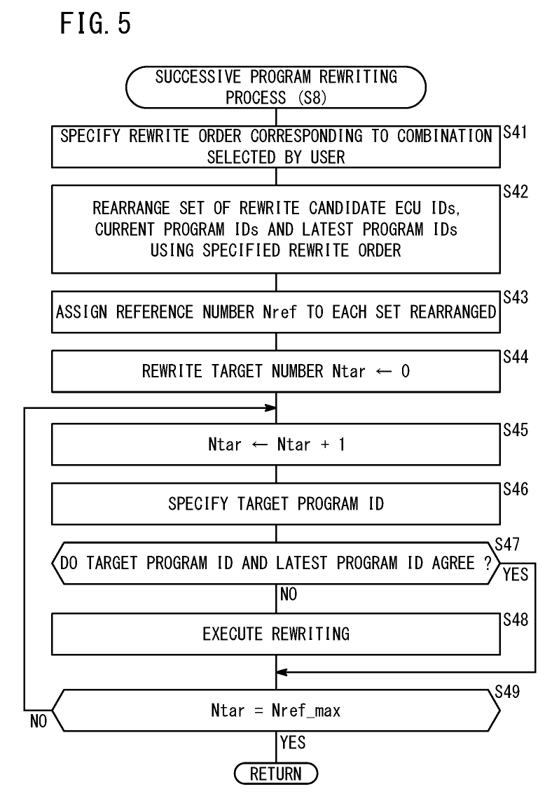

Further, the rewriting order Op is the order of program rewriting of the target ECU 62tar. Further details of the rewriting order Op will be described later in connection with step S41 in FIG. 5.

The set DB 54 (rewrite candidate database) stores sets for rewrite candidate ECUs 62 (hereinafter referred to as “rewrite candidate ECUs 62can” or “candidate ECUs 62can”) for each target operation Otar to be changed of the vehicle 14. More specifically, the set DB 54 stores sets of set numbers Nset, target operations Otar to be changed, dates, and identification codes (hereinafter also referred to as “rewrite candidate ECU ID” or “candidate ECU ID”) of the candidate ECUs 62can, program IDs (hereinafter also referred to as “rewrite candidate program ID” or “candidate program ID”) corresponding to the candidate ECUs 62can (See FIG. 2). The candidate program ID includes a program name and version information Iver. Hereinafter, the information stored in the set DB 54 is also referred to as rewrite candidate information Ican.

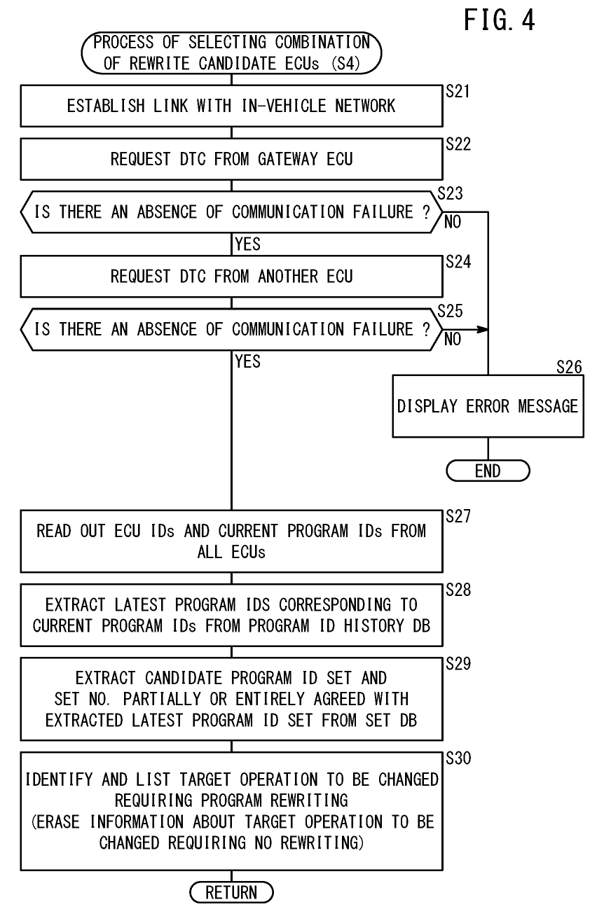

The rewrite program DB 56 stores the rewrite program Pr. The program DB 56 of the present embodiment stores the latest version of the rewrite program Pr having the same program name. In FIG. 2, programs P1 and P2 are shown as rewrite program Pr. The rewriting list 58 is a list (storage area) temporarily created for program rewriting. The method of using the list 58 will be described later with reference to the flowcharts of FIGS. 4, 5 and 7 and the like.

### (A1-3. Vehicle 14)

As shown in FIG. 1, the vehicle 14 includes the communication network 60 (hereinafter also referred to as “in-vehicle network 60” or “network 60”.). The network 60 includes a plurality of ECUs 62a to 62j connected by a communication line 64. The network 60 is connected to the program rewriting device 12 via a data link connector 66 (hereinafter also referred to as “DLC 66”).

Each of the ECUs 62a to 62j controls each part of the vehicle 14. Among the plurality of ECUs 62a to 62j, the first ECU 62a has a gateway function. That is, the first ECU 62a is a network node for connecting the network 60 to a network of the program rewriting device 12 having different protocols. Hereinafter, the first ECU 62a is also referred to as a gateway ECU 62a. In FIG. 1, only one gateway ECU 62a is shown, but it is also possible to provide a plurality of gateway ECUs 62a. Further, the gateway ECU 62a or the plurality of gateway ECUs 62a are not restricted to be positioned as shown in FIG. 1, and may be arranged at an arbitrary position in the network 60.

For example, the second to tenth ECUs 62b to 62j includes an engine electronic control unit (hereinafter referred to as “ENG ECU”), an anti-lock brake system electronic control unit (hereinafter referred to as “ABS ECU”), an auxiliary restraint system electronic control unit (hereinafter referred to as “SRS ECU”), and an immobilizer electronic control device. The ENG ECU controls an output of an engine (not shown). The ENG ECU is connected to an engine rotation speed sensor (not shown) for detecting the engine rotation speed Ne [rpm] and to a vehicle speed sensor (not shown) for detecting the vehicle speed V [km/h] of the vehicle 14. The ABS ECU performs control of a brake system (not shown). The SRS ECU performs control of an air bag (not shown). The immobilizer ECU controls the immobilizer device (not shown).

Each of the ECUs 62a to 62j performs data communication with each other via the communication line 64. More specifically, among the ECUs 62a to 62j, based on communication data (for example, data of the engine rotation speed Ne and the vehicle speed V) from a specific ECU 62 (for example, the ENG ECU), other ECUs 62 (for example, the ABS ECU, the SRS ECU and the immobilizer ECU) control the vehicle 14 cooperatively. Further, the ECUs 62a to 62j mutually perform failure diagnosis (abnormality detection of communication data).

The second to fourth ECUs 62b, 62c, 62d form a first lower-level network 68a. The fifth to seventh ECUs 62e, 62f, 62g form a second lower-level network 68b. The eighth to tenth ECUs 62h, 62i, 62j form a third lower-level network 68c. The first to third lower-level networks 68a to 68c constitute, for example, a CAN (Controller Area Network). The CAN here may be a high speed CAN, for example. In the example of FIG. 1, ten ECUs 62a to 62j are shown, but the number of the ECUs 62 is not limited thereto, and may be any value between 3 and 200, for example.

As shown in FIG. 1, the first ECU 62a includes a signal input/output unit 70, a calculator 72, and a storage unit 74. Although not shown in FIG. 1, the second to tenth ECUs 62b to 62j also have the same configuration as the first ECU 62a. However, specifications differ in the first to tenth ECUs 62a to 62j.

Each of the ECUs 62a to 62j is turned on and off with an ignition switch 80 (hereinafter referred to as “IGSW 80”) as a startup switch. More specifically, each of the ECUs 62a to 62j is connected to a battery 82 (power storage device) via a power line (not shown) and an IGSW 80 disposed on the power line.

The IGSW 80 of the present embodiment is of a rotary type, and it is possible to select the positions of “OFF”, “ACC” (accessory) and “ON” from the left side facing an instrument panel (not shown). Further, when the IGSW 80 is further turned to the right side (clockwise) from the “ON” position, it becomes the position of “ST” (engine start), and the engine starts.

In the present embodiment, when the IGSW 80 is in the “ACC” and “ON” positions, power is supplied from the battery 82 to each of the ECUs 62. When the IGSW 80 is in the “OFF” position, power supply from the battery 82 to each of the ECUs 62 is basically stopped.

In the case where the vehicle 14 has a so-called smart start function, the IGSW 80 may be a push switch used for a so-called smart start function.

The first to tenth ECUs 62a to 62j store a failure code (DTC) as a failure history in the storage unit of the first to tenth ECUs 62a to 62j when an abnormality occurs in association with own operation. In addition, the gateway ECU 62a also stores the DTC in the storage unit 26 even when an abnormality occurs in connection with the communication with the second to tenth ECUs 62b to 62j. In this failure history, a failure history relating to communication (hereinafter referred to as “communication failure history”) and other failure history (hereinafter also referred to as “non-communication failure history”) are included. The communication failure history and the non-communication failure history are collectively referred to as general failure history.

For example, when a disconnection occurs short of the eighth ECU 62h (the point 84 in FIG. 1), both the gateway ECU 62a and the eighth ECU 62h store the DTC in the storage units 74. However, in the state where disconnection occurs, the eighth ECU 62h cannot communicate with the gateway ECU 62a. Therefore, the rewriting device 12 cannot read out the DTC stored in the eighth ECU 62h. Also, when program rewriting is interrupted in each of the ECUs 62a to 62j, each of the ECUs 62a to 62j also stores the DTC as the communication failure history in its own storage unit 74.

### [A2. Program Rewrite]

Next, in the present embodiment, rewriting of the installation program Pi stored in the target ECU 62tar will be described.

### (A2-1. Preliminary Preparation)

Before rewriting the program for a specific target operation Otar to be changed, the user (or the operator) of the rewriting device 12 causes the storage unit 26 of the rewriting device 12 to store the data corresponding to the target operation Otar to be changed. More specifically, the user stores a plurality of rewrite programs Pr corresponding to the specific target operation Otar to be changed in the program DB 56 (rewrite program database).

Also, the user causes the program ID history DB 50 to store therein the program ID (including the version information Iver) and the like of each rewrite program Pr corresponding to the target operation Otar to be changed (see FIG. 2). Further, the user causes the order DB 52 to store therein the priority order information Ipo of the rewrite program Pr (see FIG. 2). Further, the user causes the set DB 54 to store therein the set numbers Nset, the candidate ECU IDs, the candidate program IDs, etc. of the rewrite program Pr (see FIG. 2). For example, the DLC 32 of the rewriting device 12 is connected to a personal computer (not shown), and the above data is copied from the personal computer to the storage unit 26.

Data to be copied to the rewriting device 12 is created by an administrator of the program rewriting system 10 and stored in an external server (not shown). The data stored in the external server is downloaded to the personal computer. When the rewriting device 12 has a communication function with the external server, the rewriting device 12 can also acquire data directly from the external server.

### (A2-2. Actual Rewriting)

### (A2-2-1. Overall Flow at Rewriting)

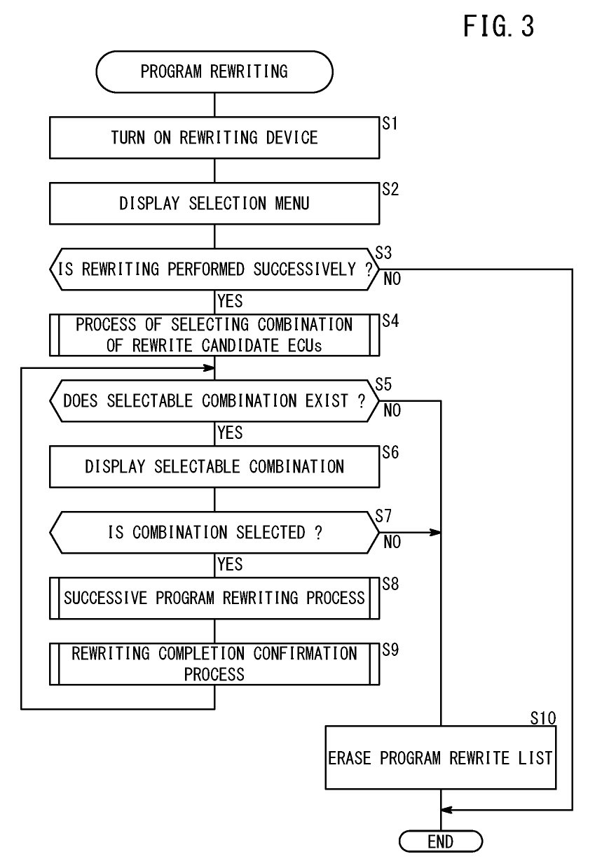

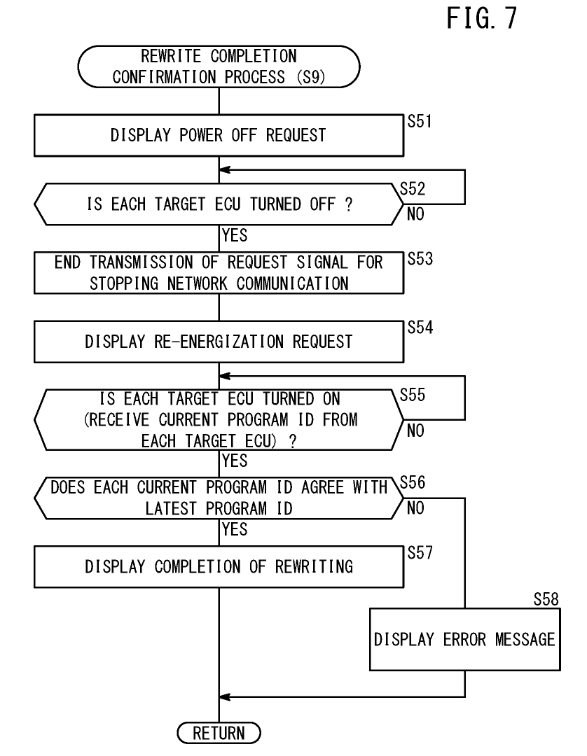

FIG. 3 is a flowchart for program rewriting in this embodiment. FIG. 3 and FIG. 4, FIG. 5 and FIG. 7 which will be described later are mainly executed by the calculator 24 (rewrite controller) of the rewriting device 12. In step S1 of FIG. 3, when the user turns on the power switch (not shown) of the rewriting device 12, the rewriting device 12 is activated. In step S2, the rewriting device 12 displays a selection menu on the display unit 28. The selection menu includes, for example, successive rewriting of the program P, individual rewriting of the program P, and the like. The successive rewriting is a menu for rewriting the programs Pi of the plurality of target ECUs 62tar successively, and the individual rewrite is a menu for rewriting the program Pi of the single target ECU 62tar.

When successive rewriting of the program P in the selection menu is selected (S3: YES), the program P is successively rewritten in steps S4 to S10. When a menu other than the successive rewriting of the program P is selected (S3: NO), the selected menu is executed (the steps corresponding to this menu are not shown in FIG. 3)

In step S4, the rewriting device 12 performs a process of selecting a combination of rewrite candidate ECUs 62can (hereinafter referred to as “process of combination selection of rewrite candidate ECUs” or “combination selection process”). Details of step S4 will be described later with reference to FIG. 4. In step S5, the rewriting device 12 determines if there is a combination of selectable rewrite candidate ECUs 62can, as a result of the combination selection process. If there is (S5: YES), the process proceeds to step S6.

In step S6, the rewriting device 12 causes the display unit 28 to display selectable combinations. When there is only one selectable combination, the only combination is displayed. In addition, even if the combination determined to be selectable in the process of selecting the combination of rewrite candidate ECUs includes an ECU 62 for which rewriting prohibition setting is made, the rewriting device 12 may notify the prohibition on the display unit 28.

In the case where there are a plurality of selectable combinations, the rewriting device 12 may display only the latest combinations based on the dates stored in the set DB 54. As a result, if different version information Iver related to the same ECU 62 is included in each combination, it becomes possible to rewrite the program Pr of the latest version first. As a result, it is possible to omit rewriting of the older version program Pr.

In step S7, the rewriting device 12 determines whether any combination has been selected by the user via the operation input unit 22. When any combination has been selected (S7: YES), the process proceeds to step S8. When any combination has not been selected and an end of successive rewriting is selected (S7: NO), the process proceeds to step S10.

In step S8, the rewriting device 12 performs a process of successively rewriting the program for each of the ECU 62 (target ECU 62tar) that actually rewrites the program from among the plurality of rewrite candidate ECUs 62can included in the selected combination (hereinafter referred to as “successive program rewriting processing”). Details of step S8 will be described later with reference to FIG. 5. In step S9, the rewriting device 12 performs a process of confirming completion of program rewriting (hereinafter referred to as “rewrite completion confirming process”). Details of step S9 will be described later with reference to FIG. 7. After step S9, the process returns to step S5.

When there is no combination of selectable rewrite candidate ECUs 62can in step S5 (S5: NO), the rewriting device 12 deletes the rewrite list 58 temporarily created for program rewriting in step S10 and the successive rewriting of the program P is ended. The list 58 will be described later in step S30 and so on in FIG. 4.

### (A2-2-2. Process of Combination Selection of Rewriteable Candidate ECUs (Detail of S4 in FIG. 3))

FIG. 4 is a flowchart (details of S4 in FIG. 3) of the process of the combination selection of the rewrite candidate ECUs, according to the present embodiment. In step S21 of FIG. 4, the rewriting device 12 establishes a link with the in-vehicle network 60. Upon establishing the link, the rewriting device 12 waits for a predetermined time until the sessions in the ECUs 62a to 62j are completed.

In step S22, the rewriting device 12 requests the gateway ECU 62a for DTC. In response to the request, the gateway ECU 62a transmits the DTC to the rewriting device 12 if there is a DTC stored in its own storage unit 74. If there is no DTC, the gateway ECU 62a makes a reply notifying that DTC is not recorded. Alternatively, when there is no DTC, the gateway ECU 62a may not respond.

In step S23, based on the response from the gateway ECU 62a, the rewriting device 12 determines whether there is a communication failure in the gateway ECU 62a. For example, when receiving the DTC from the gateway ECU 62a, the rewriting device 12 determines whether the DTC is related with a communication failure history. Alternatively, when the gateway ECU 62a outputs a response notifying that the DTC is not recorded, the rewriting device 12 can judge a communication failure in the gateway ECU 62a based on whether or not there is any response from the gateway ECU 62a.

When there is no communication failure in the gateway ECU 62a (S23: YES), the rewriting device 12 requests the DTC from the other ECUs 62 (second to tenth ECUs 62b to 62j) than the gateway ECU 62a in step S24. In response to the request, the second to tenth ECUs 62b to 62j transmit to the rewriting device 12, if there is a DTC stored in their own storage units 74. If there is no DTC, the second to tenth ECUs 62b to 62j answer that the DTC is not recorded. Alternatively, the second to tenth ECUs 62b to 62j may not respond when DTC is not recorded.

In step S25, based on the responses from the other ECUs 62 (second to tenth ECUs 62b to 62j), the rewriting device 12 determines a communication failure in the other ECUs 62 (second to tenth ECUs 62b to 62j). This determination can be performed in the same manner as in step S23. When there is no communication failure in the other ECUs 62 (second to tenth ECUs 62b to 62j) (S25: YES), the process proceeds to step S27.

When there is a communication failure in the gateway ECU 62a (S23: NO) or when there is a communication failure in any of the ECUs 62 (second to tenth ECUs 62b to 62j) other than the gateway ECU 62a (S25: NO) in step S23, the rewriting device 12 causes the display unit 28 to display an error message for notifying the communication failure in step S26.

In step S27, the rewriting device 12 acquires the ECU IDs (system ID) and current program IDs from all the ECUs 62 (first to tenth ECUs 62a to 62j) included in the network 60 and having rewritable programs. The current program ID includes a program name and current version information Iver.

In subsequent steps S28 to S30, the target operation Otar required to be changed in the vehicle 14 is specified. That is, in step S28, the rewriting device 12 retrieves the latest program ID corresponding to each of the current program IDs read out in step S27 from the program ID history DB 50. Then, the rewriting device 12 holds the extracted latest program ID in association with the ECU ID and the current program ID.

In the present embodiment, one ECU 62 has only one program Pi (see FIG. 2). Therefore, at the time of extracting the latest program ID (S28), the latest program ID may be specified by using the ECU ID instead of the current program ID.

In step S29, the rewriting device 12 extracts and retains candidate program ID set including data partially or completely agrees with the latest program ID set extracted from the set DB 54 and the set number Nset (in other words, the target operation Otar to be changed). In this manner, it is possible to identify one or a plurality of candidates for the target operation Otar that the vehicle 14 requires to be changed.

In step S30, the rewriting device 12 specifies the target operation Otar requiring program rewriting in the vehicle 14 for the change and registers it in the list 58.

That is, the rewriting device 12 judges whether or not there is a current program ID that does not agree with the latest program ID even when the program name is the same, for each set (target operation Otar to be change). Then, the rewriting device 12 extracts a set (a target operation Otar to be changed) in which a current program ID that does not agree with the latest program ID as the set (target operation Otar to be changed) which requires program rewriting. The rewriting device 12 registers the extracted information on the set (set number Nset, ECU ID, current program ID and latest program ID) in the list 58. The set registered in this list 58 is a selectable set in step S5 of FIG. 3.

On the other hand, it can be determined that program rewriting has been completed in a case where there is no set in which the current program ID does not agree with the latest program ID, and the program rewriting is no longer required. Accordingly, the rewriting device 12 erases (or stops retaining) the information on the set in which there is no current program ID which does not agree with the latest program ID. If there is no set to be registered in the list 58, the rewriting device 12 notifies it on the display unit 28.

### (A2-2-3. Successive Program Rewriting Process (Details of S8 in FIG. 3))

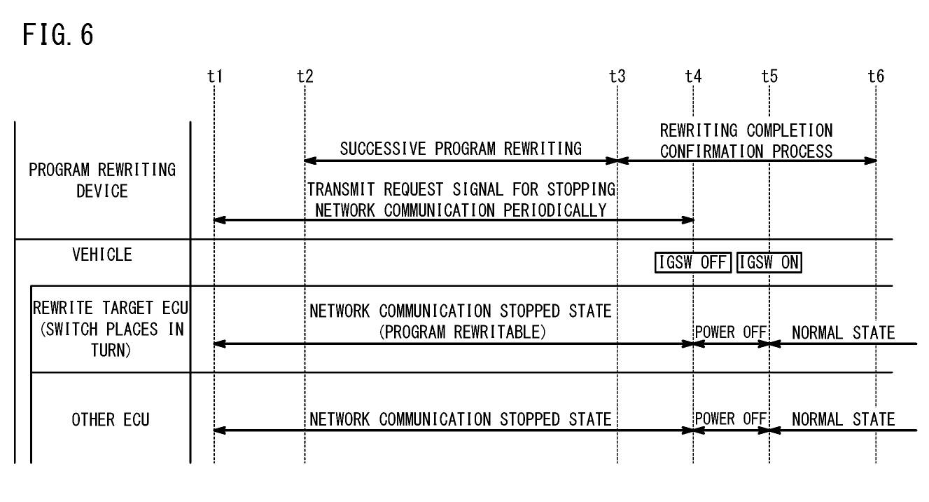

FIG. 5 is a flowchart (details of S8 in FIG. 3) of the successive program rewriting process in the present embodiment. FIG. 6 is a diagram for explaining the communication state and operation state of the rewriting device 12 and each of the ECUs 62 in the successive program rewriting processing and the rewrite completion confirmation processing in the present embodiment. As described above, the successive program rewriting processing (S8 in FIG. 3) is performed after the user selects one of the combinations that can be selected in step S7 in FIG. 3. In the successive program rewriting processing shown in FIG. 6, the actual successive program rewriting (S48 and so on in FIG. 5) is executed during the period from time t2 to time t3, and the rewrite completion confirmation processing is executed at time t3 to time t6.

In step S41 of FIG. 5, the rewriting device 12 specifies the rewriting priority order Op corresponding to the set (or the set number Nset or the target operation Otar to be changed) selected by the user using the priority order information Ipo of the order DB 52.

For setting the rewriting order Op in the order DB 52, for example, the following is used as the rules (or standard).

(Rule 1) For the gateway ECU 62a (upper level ECU), the order of rewriting is later than that of the other ECUs 62b to 62j (lower level ECU).

(Rule 2) With respect to an ECU 62 (data providing ECU) that outputs data used for rewriting of another ECU 62, the order of rewriting is later than that of the other ECU 62.

Regarding Rule 1, if the program P of the gateway ECU 62a is rewritten first, the gateway ECU 62a stops the communication mediating function until restarting. For this reason, rewriting of the gateway ECU 62a is performed later.

Regarding Rule 2, if the program P of the data providing ECU is rewritten first, the data providing ECU stops providing data necessary for rewriting of the other ECU 62 until restarting. For this reason, rewriting of the data providing ECU is performed later. As a case related to Rule 2, for example, there is a case where the data providing ECU provides the vehicle speed V to another ECU 62 to be rewritten on the condition that the vehicle speed V is zero [km/h] as an initiation condition of the program rewriting of the other ECU 62.

In step S42 of FIG. 5, the rewriting device 12 rearranges the sets of the candidate ECU IDs, the current program IDs, and the latest program IDs by using the rewriting order Op specified in step S41. The sets of the candidate ECU IDs, the current program IDs, and the latest program IDs before rearrangement are registered in the list 58 through steps S27 to S30 in FIG. 4

In step S43, the rewriting device 12 assigns a reference number Nref to each set of the rearranged candidate ECU ID, current program ID and latest program ID. The reference number Nref indicates the order of rewriting for each set.

In step S44, the rewriting device 12 resets a rewriting target number Ntar (hereinafter also referred to as “target number Ntar”) indicating the reference number Nref whose turn for rewriting has come to zero. In step S45, the rewriting device 12 adds 1 to the current value of the rewriting target number Ntar and sets a new target number Ntar. After finishing program rewriting for a certain ECU 62, before or after step S44, the rewriting device 12 waits for a predetermined time until a session in another ECU 62 ends before starting program rewriting for the other ECU 62.

In step S46, the rewriting device 12 updates the current program ID (also referred to as “target program ID”) corresponding to the candidate ECU 62can having the reference number Nref that matches the rewrite target number Ntar. In step S47, the rewriting device 12 compares the target program ID having the same program name and the latest program ID, and confirms whether both coincide. If they match (S47: YES), the installed program Pi is already the latest version. In this case, the program proceeds to step S49 without program rewriting to the candidate ECU 62can having the reference number Nref that matches the rewriting target number Ntar.

On the other hand, when the two do not match (S47: NO), since the installed program Pi is not the latest version, rewriting of the installed program Pi is necessary. In this case, the candidate ECU 62can is set as the target ECU 62tar. In step S48, the rewriting device 12 executes program rewriting for the target ECU 62tar having the reference number Nref that matches the rewriting target number Ntar.

Further, the rewriting device 12 starts periodical transmission of a network communication stop request signal Sstp (hereinafter also referred to as “communication stop request signal Sstp” or “stop request signal Sstp”) to each of the ECUs 62. The stop request signal Sstp is a signal for requesting the ECUs 62a to 62j (target ECU 62tar and other ECU 62) to stop mutual communication between each of the ECUs 62 and prohibit DTC storage. Transmission of the stop request signal Sstp is started before execution of program rewriting starts (see FIG. 6).

The transmission of the stop request signal Sstp is performed at a predetermined interval (for example, every 2 to 4 seconds). The ECUs 62a to 62j which have received the stop request signal Sstp stop communication through the network 60 and stop communication-related DTC storage and outputting for a predetermined period (for example, any one of 4 to 10 seconds). In this manner, while the rewriting device 12 continues to transmit the stop request signal Sstp, the ECUs 62 other than the target ECU 62tar continue to stop the network communication and the communication-related DTC storage. The stop request signal Sstp may request for abeyance of network communication until a request signal for cancelling the abeyance of network communication (request release signal Sfin) is transmitted.

It should be noted that in step S48, the target ECU 62tar that has completed the program rewriting is not rebooted. Reboot of the target ECU 62tar is performed in the rewrite completion confirmation process (S51 to S55 in FIG. 7 to be described later).

In FIG. 6, it is shown that the rewriting device periodically transmits the communication stop request signal Sstp during the time point t1 to t3. Each of the ECUs 62a to 62j which has received the stop request signal Sstp enters a communication stop state in which mutual communication is stopped. However, communication with the rewriting device 12 is possible for the target ECU 62tar to which the program rewriting is actually carried out in order to rewrite the program.

In step S49, the rewriting device 12 determines whether the rewriting target number Ntar is equal to the maximum value Nref max of the reference number Nref. If the rewriting target number Ntar is not equal to the maximum value Nref max (S49: NO), there is a candidate ECU 62can which has not finished checking whether or not the installed program Pi is the latest version. Therefore, the process returns to step S45. When the rewriting target number Ntar is equal to the maximum value Nref max (S49: YES), all the candidate ECUs 62can in the combination have finished checking whether or not the installed program Pi is the latest version. Therefore, the rewriting device 12 ends the successive program rewriting process and proceeds to the rewrite completion confirming process (S9 in FIG. 3, FIG. 7).

### (A2-2-4. Rewrite Completion Confirmation Processing (Details of S9 in FIG. 3))

### (A2-2-4-1. Overall Flow)

FIG. 7 is a flowchart (details of S9 in FIG. 3) of the rewrite completion confirmation process in the present embodiment. In step S51, the rewriting device 12 causes the display unit 28 to display a power-off request that asks the user to turn off the target ECU 62tar. In the power off request in the present embodiment, the user is requested to turn off the IGSW 80. It should be noted that the communication stop request signal Sstp continues to be transmitted periodically from the time of step S48 in FIG. 5.

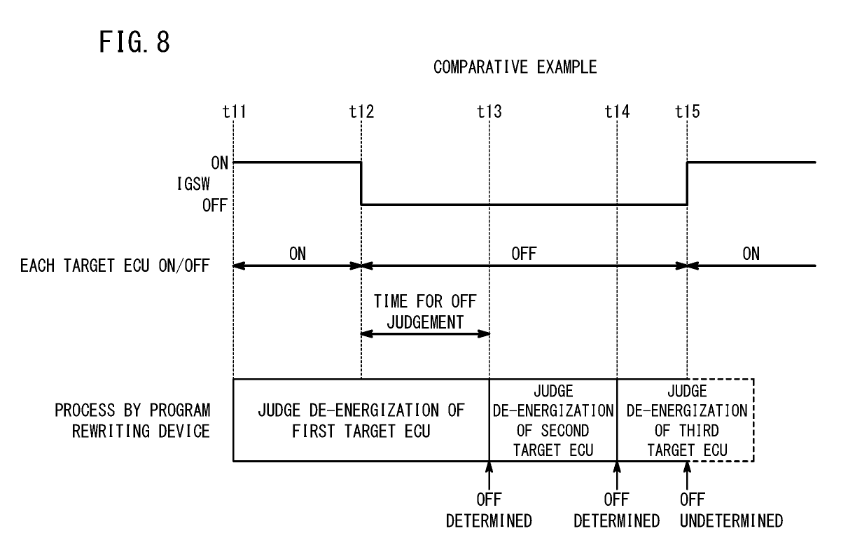

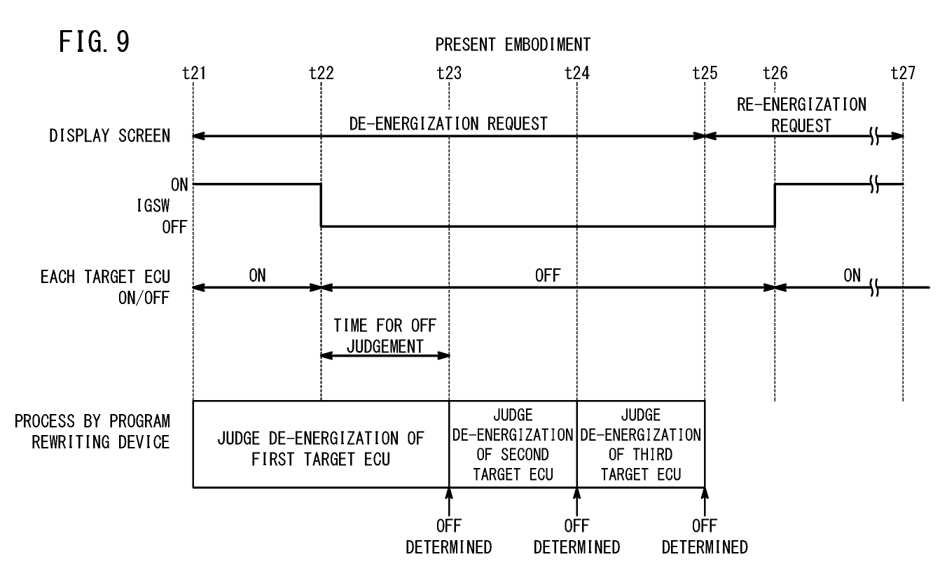

In step S52, the rewriting device 12 checks whether each target ECU 62tar is turned off. Specifically, the rewriting device 12 transmits the first operation check signal Scnf1 to all the target ECUs 62tar. Then, the rewriting device 12 confirms the power-off of each target ECU 62tar based on the absence of a response to the first operation check signal Scnf1. As the first operation check signal Scnf1, for example, a battery voltage request signal for requesting the reading of the voltage of the battery 82 can be used. It is also possible to make such determination by outputting an on/off signal of the IGSW 80 to the rewriting device 12. In the present embodiment, confirmation as to whether the power-off is performed one by one for each target ECU 62tar (details will be described later with reference to FIGS. 8 and 9).

When any of the target ECU 62tar is not turned off (S52: NO), the process returns to step S52. However, if any of the target ECU 62tar does not turn off the power even after the lapse of the predetermined period, the rewriting device 12 may notify it through an indication on the display unit 28. When all the target ECU 62tar is turned off (S52: YES), the process proceeds to step S53.

In step S53, the rewriting device 12 terminates transmission of the communication stop request signal Sstp to each of the ECUs 62a to 62j (time t4 in FIG. 6). In step S54, the rewriting device 12 causes the display unit 28 to display to the user a request for turning on each target ECU 62tar again. In response to the request for re-energization in the present embodiment, the user is requested to turn on the IGSW 80 again.

In step S55, the rewriting device 12 determines whether all the target ECU 62tar has been turned on (in other words, whether all the target ECU 62tar has rebooted). Specifically, the rewriting device 12 transmits the second operation check signal Scnf2 to all the target ECUs 62tar. Then, the rewriting device 12 confirms the power-on of each target ECU 62tar with a response to the second operation check signal Scnf2.

As the second operation check signal Scnf2, a current program ID request signal Sreqpid (hereinafter also referred to as “ID request signal Sreqpid”) requesting the current program ID of each target ECU 62tar can be used. As described above, the current program ID includes the program name and current version information Iver. Therefore, the ID request signal Sreqpid also functions as a version information request signal. By using the ID request signal Sreqpid as the second operation check signal Scnf2, it is possible to smoothly perform the process of step S56 described later. By outputting the on/off signal of the IGSW 80 to the rewriting device 12, it is also possible to make the determination in step S56.

When any of the target ECU 62tar is not turned on (S55: NO), step S55 is repeated. That is, the rewriting device 12 continues transmitting the ID request signal Sreqpid to the target ECU 62tar from which the current program ID has not been received. However, if any of the target ECU 62tar does not turn on the power even after the lapse of the predetermined period, the rewriting device 12 may cause the display unit 28 to display the absence. When all the target ECU 62tar is turned on (S55: YES), the process proceeds to step S56.

In step S56, the rewriting device 12 determines whether or not the current program IDs of all the target ECUs 62tar match the latest program ID. In other words, the rewriting device 12 judges whether or not the version information Iver and the latest version information Iver match with respect to the installed program Pi of each target ECU 62tar. Note that the latest program ID here is registered in the list 58. In addition, when confirming the power-on of each target ECU 62tar by means other than the ID request signal Sreqpid in step S55, the ID request signal Sreqpid is transmitted to each target ECU 62tar during steps S55 and S56, and the current program ID of each target ECU 62tar is obtained.

When the current program ID of all the target ECU 62tar matches the latest program ID (S56: YES), the rewriting device 12 displays the rewrite completion on the display unit 28 in step S57, and then ends the rewrite completion confirmation processing. When the current program ID of any of the target ECU 62tar does not match the latest program ID (S56: NO), the rewriting device 12 causes the display unit 28 to display an error message to that effect in step S58.

### (A2-2-4-2. Relationship Between Determination on Power-Off of Each Target ECU 62tar (Step S52 in FIG. 7) and Display on Display Unit 28 (S51, S54))

In step S52 of FIG. 7, as described above, power-off of each target ECU 62tar is confirmed in turn. In this case, it is possible to reliably confirm that each target ECU 62tar is turned off. On the other hand, since the time required for the confirmation is relatively long, if the IGSW 80 is turned off once and turned on soon, it is not possible to determine the power-off of each target ECU 62tar. In that case, there is a possibility that it cannot proceed to step S53 merely by repeating step S52 of FIG. 7

Therefore, in the present embodiment, by using the display (S51, S54) of the display unit 28, it is possible to reliably determine a judgement that each target ECU 62tar is turned off. This aspect will be described more specifically with reference to FIGS. 8 and 9.

FIG. 8 is a diagram showing an example of how the target ECU 62tar sequentially checks power-off in a comparative embodiment. In the comparative embodiment (and the example in FIG. 9), the number of the target ECU 62tar is three. In this comparative embodiment, the display (S51, S54 in FIG. 7) of the display unit 28 in the present embodiment is not used. Instead, the user (or operator) of the rewriting device 12 obtains information on the operation from the maintenance manual or the like. In the comparative embodiment of FIG. 8, since the user turns on the IGSW 80 too soon after the IGSW 80 is turned off, it is not possible for the rewriting device 12 to determine if the third target ECU 62tar (for example, the first ECU 62a) is turned off.

That is, in FIG. 8, the rewriting device 12 starts to judge whether the first target ECU 62tar (for example, the fourth ECU 62d) is turned off from time t11. At time t12, when the user turns off the IGSW 80, each target ECU 62tar is turned off. From the time point t12 to the time point t13, the rewriting device 12 determines that the first target ECU 62tar is turned off. Next, the rewriting device 12 starts the judgment if the second target ECU 62tar (for example, the seventh ECU 62g) is turned off. From time t13 to time t14, the rewriting device 12 determines that the second target ECU 62tar is turned off.

Next, the rewriting device 12 starts to judge whether the third target ECU 62tar (for example, the first ECU 62a) is turned off. At time t15, the user turns on the IGSW 80. As a result, all three target ECUs 62tar are restarted. On the other hand, at time t15, the rewriting device 12 has not yet determined that the third target ECU 62tar is turned off. Therefore, since the third target ECU 62tar is not turned off, the rewriting device 12 cannot proceed to step S53 in FIG. 7.

FIG. 9 is a diagram showing an example of how each target ECU 62tar is turned off sequentially in the present embodiment. In the example of FIG. 9, the display unit 28 does not display the request for turning on (IGSW on request) again until it is determined that all the target ECUs 62tar have been turned off. Therefore, it is possible for the operator to take sufficient time from the turn-off operation of the IGSW 80 to the re-energization operation, and the rewriting device 12 is able to determine that the third target ECU 62tar (for example, the first ECU 62a) is turned off.

That is, in FIG. 9, the rewriting device 12 starts to judge whether the first target ECU 62tar (for example, the fourth ECU 62d) is turned off from time t21. At this time, the rewriting device 12 causes the display unit 28 to display a power-off request (S51 in FIG. 7).

At time t22, when the user turns off the IGSW 80, each target ECU 62tar is turned off. From the time t22 to the time t23, the rewriting device 12 fixes the judgement that the first target ECU 62tar is turned off. Next, the rewriting device 12 starts to determine whether the second target ECU 62tar (for example, the seventh ECU 62g) is turned off. From the time point t23 to the time point t24, the rewriting device 12 fixes the judgement that the second target ECU 62tar is turned off.

Next, the rewriting device 12 starts to judge whether the third target ECU 62tar (for example, the first ECU 62a) is turned off. In the example of FIG. 9, the power-off request on the display unit 28 continues to be displayed on the display unit 28. Therefore, unlike the comparative embodiment of FIG. 8, the user does not turn on the IGSW 80. The rewriting device 12 may switch the display on the display unit 28 from the power off request to the standby request at a point in time when it is determined that the first target ECU 62tar is turned off.

From the time point t24 to the time point t25, the rewriting device 12 fixes the judgement that the third target ECU 62tar is turned off. Along therewith, the rewriting device 12 switches the display on the display unit 28 to the re-energization request (S54 in FIG. 7). At time t26, the operator turns on the IGSW 80. As a result, all three target ECUs 62tar are restarted. When each target ECU 62tar is turned on (S55 in FIG. 7: YES), the rewriting device 12 ends the display of the re-energization request (time t27).

As described above, in the example of FIG. 9, the rewriting device 12 can fix the judgement that all the target ECUs 62tar have been turned off, so that the process can proceed to step S53 in FIG. 7.

### [A3. Effects According to Present Embodiment]

As described above, program rewriting is performed with the priority order Op corresponding to the combination of the ECUs 62 (target ECU 62tar) that need to be rewritten in each target operation Otar to be changed of the vehicle 14 (FIG. 5). Therefore, it is possible to rewrite the program in the most appropriate order for the vehicle 14.

Further, according to the present embodiment, with respect to the target ECUs 62tar, which are the candidate ECUs 62can whose current program ID (present version information Iver) do not coincide with the latest program ID (latest version information Iver), in accordance with the priority order Op for each target operation Otar to be changed, rewriting to the latest version of the program P is successively executed (FIGS. 4 and 5). For this reason, rewriting is performed only on the candidate ECUs 62can that need to be rewritten, so that rewriting operation can be performed efficiently.

According to the above description, even when a service provider such as a dealer or the like performs program rewriting for the vehicle 14 on the market, the maintenance operator will not mistake the selection of the target ECUs 62tar. In addition, it is possible to reduce the burden of operation for specifying the rewriting order Op, and it is possible to implement an appropriate rewriting operation easily.

Even if there is a target ECU 62tar which failed to be rewritten during program rewriting, rewriting operation is performed again. As a result, it is possible to rewrite the target ECU 62tar which has not been rewritten, except for the target ECU 62tar which has already been successfully rewritten.

In the present embodiment, the calculator 24 (rewrite controller) of the rewriting device 12 registers the rewrite candidate ECU 62can paired with the current version information Iver which does not match the latest version information Iver as the target ECU 62tar in the list 58 (FIG. 4). Further, the rewriting device 12 executes the program rewriting operation with the priority order Op stored in the order DB 52 for the latest version of the program P for the target ECU 62tar registered in the list 58 (S8 in FIG. 3, FIG. 5). This makes it possible to identify the combination of the target ECU 62tar (or the combination of the program P corresponding to the target ECU 62tar) requiring program rewriting by a simple method.

In the present embodiment, when the gateway ECU 62a and the other ECU 62 (any one or more of the second to tenth ECUs 62b to 62j) are target ECUs 62tar, the gateway ECU 62a is positioned later than the other ECU 62 in the rewriting order Op (S41 in FIG. 5). Thus, when consecutively rewriting a plurality of ECUs 62, it is possible to rewrite the programs successively in the other ECU 62 and the gateway ECU 62a without being affected by changes in the usage data due to rewriting of other cooperating ECUs 62.

In this embodiment, the rewriting order of the ECU 62 (data providing ECU) that outputs data to be used for rewriting of the other ECU 62 is set to be later than the other ECU 62 (S41 in FIG. 5). As a result, data supply to the rewriting device 12 or another ECU 62 is not affected by rewriting of the data providing ECU, and program rewriting for the other ECU 62can and the data providing ECU be successively performed.

In the present embodiment, the rewrite program DB stores the latest version of the rewrite program Pr having the same program name. In addition, when there are a plurality of target operations Otar to be changed, the calculator 24 (rewrite controller) of the rewriting device uses the rewrite candidate information Ican corresponding to the newest target operation Otar to be changed.

In the case where the latest version information Iver of the program P is stored for each target operation Otar to be changed of the vehicle 14, even if the program P having the same program name is stored, the rewrite candidate information Ican stored more recently (newer date) contains a new version of rewrite program Pr. Therefore, if rewriting is performed based on the rewrite candidate information Ican stored more recently, the program P of the ECU 62 (target ECU 62tar) to be rewritten is rewritten to the latest version. Therefore, when rewriting based on the former rewrite candidate information Ican, if the same ECU 62 is included, rewriting of the installed program Pi of the ECU 62 becomes unnecessary. This makes it possible to shorten the operation time of the operator when there are plural pieces of rewrite candidate information Ican.

According to the present embodiment, before the program rewriting, the mutual communication in all the ECUs 62a to 62j is stopped and the storage of the DTC is prohibited (S48 in FIG. 6, FIG. 5). Further, when the successive program rewriting (S8 in FIG. 3, FIG. 5) in all target ECU 62tar ends, it stops all the target ECU 62tar (S52 in FIG. 7: YES). Then, the transmission of the network communication stop request signal Sstp (stop/prohibition request signal) is stopped (S53). In addition, after stopping the transmission of the stop request signal Sstp, the current program ID request signal Sreqpid (version information request signal) requesting current version information Iver (version information of the installed program Pi) is transmitted to the target ECU 62tar (S55). Further, based on the current version information Iver received from the target ECU 62tar, it is confirmed that program rewriting is completed (S56).

Accordingly, it is possible to reduce the burden on the operator drastically by performing the operation (restart operation) for restarting the target ECU 62tar collectively after the successive program rewriting of all the target ECU 62tar. Therefore, even when program rewriting of the vehicle 14 on the market is performed by a maintenance operator such as a dealer or the like, appropriate rewriting operation can be easily performed.

In the present embodiment, the calculator 24 (rewrite controller) of the rewriting device 12 sends the first operation check signal Scnf1 to each target ECU 62tar after the program rewriting (S8 of FIG. 3) in all the target ECU 62tar ends (S9 of FIG. 3, S52 of FIG. 7). Then, the calculator 24 detects the stoppage of all the target ECUs 62tar based on the absence of a response to the first operation check signal Scnf1 (S52 of FIG. 7).

This makes it easier to judge the stoppage because only the rewritten ECU 62 stops being detected as compared with the case where the first operation check signal Scnf1 is transmitted to all the rewritable all ECUs (the target ECU 62tar) at one time. In addition, it is possible to shorten the time required for confirmation. Further, regarding the target ECU 62tar which has been subjected to rewriting, each target ECU 62tar is detected as being stopped based on the absence of a response to the first operation check signal Scnf1, and the subsequent processing is performed. Therefore, it is possible to reboot each target ECU 62tar reliably.

In the present embodiment, after the program rewriting (S8 of FIG. 3) for all the target ECUs 62tar ends, the calculator 24 (rewrite controller) of the rewriting device 12 requests the display unit 28 to display a request for an operation of turning off the IGSW 80 (or the battery 82 (power supply for the ECU 62)) inside the vehicle 14 (S9 in FIG. 3, S51 in FIG. 7). After terminating the transmission of the stop request signal Sstp upon detection of the stop of all the target ECU 62tar and (S52: YES in FIG. 7), the calculator 24 displays on the display unit 28 a re-energization operation request for requesting the re-energization operation on the IGSW 80 (S54). In order to request the re-energization operation, all the target ECUs 62tar should be turned off. Even in the case where the number of target ECUs 62tar is large or there is a target ECU 62tar taking a long time to be turned off, it is possible to instruct restarting operation after surely turning off all the target ECUs 62tar.

According to the present embodiment, prior to program rewriting for the target ECU 62tar, it is confirmed that there is no communication failure history relating to the communication with the network 60 with respect to each of the target ECUs 62tar (S23, S25 of FIG. 4). Upon the confirmation, it is possible to know the reason why the program rewriting device 12 cannot communicate with the target ECU 62tar is that the vehicle 14 connected to the rewriting device 12 does not have the target ECU 62tar, or that the target ECU 62tar is mounted but there is a communication failure before program rewriting is started. Therefore, it is possible to prevent communication failure from misunderstanding that the target ECU 62tar is not installed. Therefore, it is possible to reduce the trouble of rewriting the program.

In the present embodiment, the calculator 24 (rewrite controller) of the rewriting device 12 inquires the gateway ECU 62a about the communication failure history (S23 of FIG. 4). Thereafter, the calculator 24 confirms that there is no communication failure history by inquiring about the communication failure history (S25) to the ECU 62 (the second to the tenth ECUs 62a to 62j) other than the gateway ECU 62a. Thereby, when it is impossible to communicate with the target ECU 62tar, it is possible to facilitate specification of the cause part by checking whether there is a problem in the gateway ECU 62a or whether the target ECU 62tar itself or another ECU 62 has a problem.

In the present embodiment, the calculator 24 (rewrite controller) of the rewriting device 12 inquires the gateway ECU 62a about the DTC (general failure history including communication failure history). Then, the calculator 24 confirms that there is no communication failure history based on the absence of the DTC or the absence of the communication failure history in the DTC (S23 in FIG. 4). Thereafter, the calculator 24 inquires of the target ECU 62tar itself the DTC. Then, the calculator 24 confirms that there is no communication failure history based on the absence of the DTC or the absence of the communication failure history in the DTC (S25). This eliminates the need for the target ECU 62tar and the gateway ECU 62a to distinguish between the communication failure history and the other failure history, so that the configuration of each of the ECUs 62 can be simplified.

### B. Modifications

It is to be understood that the present invention is not limited to the above-described embodiment, and various configurations can be adopted based on the description contents of this specification. For example, the following configuration can be adopted.

### [B1. Applicable Target]

In the above-described embodiment, the system 10 is used for the vehicle 14. However, the present invention is not limited thereto, and other moving bodies (airplane, ship, helicopter, etc.) may be used, for example.

### [B2. Configuration of Program Rewriting System 10]

### (B2-1. Program Rewriting Device 12)

### (B2-1-1. General)

In the above embodiment, the rewriting device 12 is connected from the outside of the vehicle 14 (FIG. 1), but the present invention is not limited thereto and the rewriting device 12 may be mounted on the vehicle 14.

In the above embodiment, communication between the rewriting device 12 and the in-vehicle network 60 is performed by wire (FIG. 1). However, for example, from the viewpoint of communication with the in-vehicle network 60, it is not limited thereto, and it is also possible to perform wireless communication.

### (B2-1-2. Storage Unit 26)

The order DB 52 in the above embodiment stores the rewrite priority order Op of the ECUs 62 of plural vehicle types together (FIG. 2). However, it is not limited thereto, for example, from the viewpoint of specifying the priority order Op with respect to a specific target operation Otar to be changed. For example, it is possible for the order DB 52 to store only the priority order Op of the ECU 62 of a single vehicle type. Alternatively, the order DB 52 may store the priority order Op for each target operation Otar to be changed.

In the above embodiment, the DBs 50, 52, 54, 56 and the list 58 are provided in the rewriting device 12 (FIG. 1). However, for example, when the rewriting device has a communication function with an external server, one or more of the DBs 50, 52, 54, and 56 and the list 58 are provided in the external server, and the rewriting device 12 may acquire necessary data from the external server.

### (B2-2. Vehicle 14)

In the above embodiment, it is assumed that the vehicle 14 is a gas-powered vehicle, but the present invention is not limited thereto. The vehicle 14 may be, for example, an electric vehicle (including a hybrid vehicle, a fuel cell vehicle, etc.).

### [B3. Program Rewriting]

### (B3-1. General)

In the above embodiment, processing is performed in the form of a program ID in which the program name and version information Iver are integrated. For example, in the program ID history DB 50, the set DB 54, and the like, data is managed as a program ID (FIG. 2). However, from the viewpoint of using the program name and the version information Iver, it is also possible to manage the program name and the version information Iver separately.

In the above embodiment, the ECU ID and the program ID are set separately (FIG. 2). However, if, for example, only one type of program P is used in each of the ECUs 62, the ECU ID and the program ID can be combined and used.

### (B3-2. Process of Selecting Target ECU Combination (S4 in FIG. 3, FIG. 4))

In the above embodiment, the rewriting device 12 specifies the latest program ID by using the program ID history DB 50 (S28 in FIG. 4). However, it is not limited thereto, for example, from the viewpoint of confirming if the current program ID installed in the candidate ECU 62can is the latest version.

For example, the rewriting device 12 can treat the candidate program ID stored in the set DB 54 as the latest program ID. In this case, there is a possibility that the latest version information Iver may be different for each target operation Otar to be changed although it is the same program name. In this case, when rewriting the program with respect to a specific target operation Otar to be changed (first target operation to be changed), the rewriting device 12 may compare it with the candidate program ID related to another target operation Otar to be changed (second target operation to be changed). Then, when the version of the candidate program ID related to the second change target operation is newer than that of the candidate program ID related to the first change target operation, the candidate program ID related to the second change target operation can be used.

In the above embodiment, in the process of selecting a combination of the rewrite candidate ECUs (FIG. 4), the information of the rewrite candidate ECU 62can whose current version information Iver matches the latest version information Iver is also registered in the list 58 (S30 of FIG. 4). Then, in the successive program rewriting process (FIG. 5), when the target program ID (present program ID) matches the latest program ID (S47: YES), program rewriting is not performed.

However, the present invention is not limited thereto, for example, from the viewpoint of rewriting the program in the rewrite candidate ECU 62can in which the current version information Iver does not match the latest version information Iver. For example, the candidate ECU ID (and the candidate program ID) to be registered in the list 58 in step S30 of FIG. 4 may be limited only to the rewrite candidate ECU 62can whose current version information Iver does not match the latest version information Iver. This makes it possible to omit the process of step S47 in FIG. 5. If the set number Nset is registered in the list 58 in step S30 of FIG. 4 (part of S4 in FIG. 3), in step S5 of FIG. 3 thereafter, it is possible to determine selectable sets using the registered set numbers Nset.

In the above embodiment, the fact that there is no communication failure is judged separately for the gateway ECU 62a and the other ECU 62 (ECUs 62b to 62j) (S23 and S25 in FIG. 4). However, it is not limited thereto, for example, from the viewpoint of determining the communication failure in the entire network 60 or the target ECU 62tar. For example, it is also possible to integrate the steps S23 and S25 in FIG. 4. At that time, confirmation that there is no communication failure can be limited only to the combination of the target ECU 62tar and the gateway ECU 62a, or only to the target ECU 62tar, not all the ECUs 62a to 62j.

Further, for example, from the viewpoint of specifying the target operation Otar to be changed that requires program rewriting, it is possible to omit the confirmation that there is no communication failure (S22 to S25 in FIG. 4).

In the above embodiment, the target operation Otar to be changed requiring program rewriting is specified based on the comparison of the program IDs (S27 to S30 in FIG. 4). However, it is not limited thereto, for example, from the viewpoint of specifying the target operation Otar to be changed that requires program rewriting. For example, the target operation Otar to be changed requiring program rewriting may be specified based on the comparison of the ECU IDs. When the history of program rewriting is managed for each vehicle 14 and the target operation Otar to be changed requiring program rewriting can be specified in advance, the rewriting device 12 itself can also select the target operation Otar to be changed.

### (B3-3. Successive Program Rewriting Process (S8 in FIG. 3, S48 in FIG. 5))

In the above embodiment, the network communication stop request signal Sstp was periodically transmitted (t1 to t4 in FIG. 6). However, for example, from the viewpoint of maintaining each of the ECUs 62 in a desired state, the signal to be transmitted is not limited thereto. For example, the rewriting device 12 can also periodically send a signal requesting maintenance of the present state (a state where storage of the DTC is prohibited and mutual communication between the ECUs 62 is stopped).

### (B3-4. Rewrite Completion Confirmation Process (S9 in FIG. 3, FIG. 7))

In the above embodiment, in order to reboot each target ECU 62tar, the user of the rewriting device 12 requests the power-off operation and the re-energization operation of the IGSW 80 (S51, S54 in FIG. 7). However, the present invention is not limited thereto, for example, from the viewpoint of rebooting each target ECU 62tar. For example, it is also possible to output a reboot signal from the rewriting device 12 to each target ECU 62tar.

In the above embodiment, confirmation of power-off of each target ECU 62tar (S52 in FIG. 7) after rewriting the program is performed successively for each target ECU 62tar (FIG. 9). However, it is not limited thereto, for example, from the viewpoint of rewriting the program for each target operation Otar to be changed. For example, the rewriting device 12 can confirm the power-off of a plurality of target ECUs 62tar at the same time.

### (B3-5. Other)

In the above embodiment, the user of the rewriting device 12 selected the target operation Otar to be changed (S6, S7 in FIG. 3). In other words, the change target operation selecting section for selecting the target operation Otar to be changed is the operation input section 22 for inputting the operation of the user. However, it is not limited thereto, for example, from the viewpoint of selecting the target operation Otar to be changed. For example, it is also possible for the rewriting device 12 itself to select the target operation Otar to be changed.

### C. Explanation of Reference Numerals

12 . . . program rewriting device,
14 . . . vehicle
20 . . . signal input/output unit (network connector unit)
22 . . . operation input unit (change target operation selection unit)
24 . . . calculator (rewrite controller)
26 . . . storage unit
28 . . . display
52 . . . order DB
54 . . . set DB (rewrite candidate information database)
56 . . . program DB (rewrite program database)
58 . . . rewrite list (list)
60 . . . network
62 . . . ECU
62a . . . gateway ECU
62can . . . rewrite candidate ECU
62tar . . . target ECU
Ican . . . rewrite candidate information
Op . . . priority order
Otar . . . target operation to be changed
P . . . program
Pi . . . installed program
Pr . . . rewrite program
Scnf1 . . . first operation check signal (operation check signal)
Sreqpid . . . current program ID request signal (version information request signal)
Sstp . . . network communication stop request signal (stop/prohibition request signal)

1. A program rewriting device according to the present invention comprising a network connector for connecting from an outside of the vehicle a network of electronic control units, hereinafter referred to as “ECUs”, in a vehicle, and a rewrite controller configured to rewrite program on ECUs selected as requiring program rewriting, hereinafter referred to as “target ECUs”, the program rewriting device further comprising:
an order database in which a priority order is stored beforehand in association with identification codes of all rewritable ECUs mounted on the vehicle;
a rewrite candidate information database in which rewrite candidate information is stored as a set of the identification codes of rewrite candidate ECUs as candidates of the target ECUs and latest version information of programs installed at a time of a target operation to be changed in the rewrite candidate ECUs, per target operation to be changed in the vehicle which requires program rewriting; and
a rewrite program database in which a rewrite program is stored,
wherein the rewrite controller is configured to:
read out from all the rewritable ECUs in the network the identification codes and current version information of the installed programs of the ECUs in pairs;
extract, as the target ECUs, the rewrite candidate ECUs paired with the current version information mismatching with the latest version information based on a comparison between the current version information which has been read out and the latest version information corresponding to the current version information; and
execute program rewriting operations on the extracted target ECUs successively in the priority order stored in the order database.

2. The program rewriting device according to claim 1, wherein the rewrite controller is configured to:
register the rewrite candidate ECU paired with the current version information that does not match the latest version information as the target ECUs in a list, and
execute the program rewriting operations in the priority order stored in the order database for the target ECUs registered in the list.

3. The program rewriting device according to claim 1, wherein the priority order stored in the order database is set such that among all the rewritable ECUs, an ECU which utilizes data of another ECU is prioritized in rewriting order over the other ECU to be utilized, and
a gateway ECU having a gateway function in the network has a lower priority in execution of the program rewriting operation than other target ECUs to which communication is relayed.

4. The program rewriting device according to claim 1, wherein the rewrite program database stores the rewrite program having a same identification code for the latest version, and
wherein in case where there are a plurality of target operations to be changed, the rewrite controller uses the rewrite candidate information corresponding to a newest target operation to be changed.

5. The program rewriting device according to claim 1, wherein the rewrite controller is configured to:
transmit a stop/prohibition request signal for requesting all the ECUs to stop mutual communication and prohibit storage of failure codes;
perform the program rewriting operation successively to the target ECUs while the stop/prohibition request signal is being transmitted;
set to transmit an operation check signal to each of the target ECUs after completion of the program rewriting operation in all the target ECUs;
terminate transmission of the stop/prohibition request signal upon detecting stoppage of all the target ECUs based on no response to the operation check signal;
transmit a version information request signal for requesting all the target ECUs for the version information of the programs installed in the target ECUs; and
check if the version information received from all the target ECUs is the latest version.

6. The program rewriting device according to claim 5, wherein a rewrite controller is configured to:
sequentially transmit the operation check signal to the target ECUs one by one after the completion of the program rewriting operation in all the target ECUs; and
detect the stoppage of all the target ECUs based on no response to the operation check signal.

7. The program rewriting device according to claim 5, the rewrite controller is configured to:
cause the display unit to display an off operation request for requesting an off operation of power supply for the ECUs in the vehicle after the completion of the program rewriting operation in all the target ECUs; and
cause the display unit to display an re-energization request for requesting a re-energization operation for the ECUs after detecting the stoppage of all the target ECUs and terminating the transmission of the stop/prohibition request signal.

8. The program rewriting device according to claim 1, wherein the rewrite controller is configured to:
confirm that there is no communication failure history related to the network with respect to all of the rewritable ECUs when rewriting the programs,
if no communication failure history is confirmed with respect to any ECUs, check the identification codes of the ECUs read out from all the rewritable ECUs with the identification codes of the rewrite candidate ECUs included in the rewrite candidate information to specify the target ECUs; and
execute the program rewriting in the order stored in the order database.

9. The program rewriting device according to claim 8, wherein the rewrite controller is configured to inquire the communication failure history to a gateway ECU, which is the ECU having a gateway function in the network, and thereafter inquire the communication failure history to the ECUs other than the gateway ECU, thereby confirming that there is no communication failure history.

10. A program rewriting method in a program rewriting device including a network connector to be connected from an outside of a vehicle to a network of electronic control units, hereinafter referred to as “ECUs”, inside the vehicle, and a rewrite controller for selecting an ECU that needs program rewriting, hereinafter referred to as a “target ECU”, the program rewriting device comprising:
an order database in which a priority order is stored beforehand in association with identification codes of all rewritable ECUs mounted on the vehicle;
a rewrite candidate information database in which rewrite candidate information is stored as a set of the identification codes of rewrite candidate ECUs as candidates of the target ECUs and latest version information of programs installed at a time of a target operation to be changed in the rewrite candidate ECUs, per target operation to be changed in the vehicle which requires program rewriting; and
a rewrite program database in which a rewrite program is stored,
wherein the program rewriting method comprising steps, executed by the rewrite controller, of:
reading out from all the rewritable ECUs in the network the identification codes and current version information of the installed programs of the ECUs in pairs;
extracting, as the target ECUs, the rewrite candidate ECUs paired with the current version information mismatching with the latest version information based on a comparison between the current version information which has been read out and the latest version information corresponding to the current version information; and
executing program rewriting operations on the extracted target ECUs successively in the priority order stored in the order database.

11. The program rewriting method according to claim 10, further comprising steps, executed by the rewrite controller, of:
transmitting a stop/prohibition request signal for requesting all the ECUs to stop mutual communication and prohibit storage of failure codes;
performing the program rewriting operation successively to the target ECUs while the stop/prohibition request signal is being transmitted;
setting to transmit an operation check signal to each of the target ECUs after completion of the program rewriting operation in all the target ECUs;
terminate transmission of the stop/prohibition request signal upon detecting stoppage of all the target ECUs based on no response to the operation check signal;
transmitting a version information request signal for requesting all the target ECUs for the version information of the programs installed in the target ECUs; and
checking if the version information received from all the target ECUs is the latest version.

12. The program rewriting method according to claim 10, further comprising steps, executed by the rewrite controller, of:
confirming that there is no communication failure history related to the network with respect to all of the rewritable ECUs when rewriting the programs,
if no communication failure history is confirmed with respect to any ECUs, checking the identification codes of the ECUs read out from all the rewritable ECUs with the identification codes of the rewrite candidate ECUs included in the rewrite candidate information to specify the target ECUs; and
executing the program rewriting in the priority order stored in the order database.
